(19) United States
(12) Patent Application Publication
(10) Pub. No.: US 2019/0050122 A1
(43) Pub. Date: Feb. 14, 2019

(54) INFORMATION PROCESSING APPARATUS AND METHOD FOR FACILITATING USABILITY OF THE INFORMATION PROCESSING APPARATUS

(71) Applicant: TOSHIBA TEC KABUSHIKI KAISHA, Tokyo (JP)

(72) Inventor: Keisuke TAKAMIYA, Katsushika Tokyo (JP)

(21) Appl. No.: 16/059,722

(22) Filed: Aug. 9, 2018

(30) Foreign Application Priority Data
Aug. 10, 2017 (JP) 2017-155512

(51) Int. Cl. G06F 3/0484; G06F 3/0488; G06F 3/0482; G06Q 10/08

(52) U.S. Cl. CPC G06F 3/0484; G06Q 10/0875; G06F 3/0482; G06F 3/04886

(57) ABSTRACT

An information processing apparatus includes a touch display configured to display an application screen; a memory that stores key layout information representing a plurality of layouts for software keys; and a processor configured to: control the touch display to display a selection screen for a user to select a display position of the software keys; control the touch display to display the software keys according to one of the layouts corresponding to the selected display position; and control the touch display to display the application screen next to the displayed software keys.

### CROSS-REFERENCE TO RELATED APPLICATION

This application is based upon and claims the benefit of priority from Japanese Patent Application No. 2017-155512, filed Aug. 10, 2017, the entire contents of which are incorporated herein by reference.

### FIELD

Embodiments described herein relate generally to an information processing apparatus and a method for facilitating usability of the information processing apparatus.

### BACKGROUND

An information processing apparatus having a touch display is widely used personally and in business. To operate an application running on the apparatus, the user can use software keys (hereinafter, referred to as soft keys) displayed on the touch display.

Such a conventional information processing apparatus has a function for a user to select a display position of the soft keys, for example, through a settings screen.

However, if such a conventional information processing apparatus is used as a shared terminal by a large number of people with the same user identification code, each user has to re-set the display position of the soft keys according to his or her preference. In particular, when the application screen is designed for right-handed users by arranging the soft keys on the right side by default, left-handed users need to change the soft key layouts via the settings screen every time they log into the information processing apparatus.

### DESCRIPTION OF THE DRAWINGS

FIG. 1 is a hardware block diagram illustrating a hardware configuration of an inspection device which is an example of an information processing apparatus;

FIG. 2 is a functional block diagram illustrating a functional configuration of the inspection device;

FIG. 3 is a diagram illustrating an example of an information display screen displayed by the inspection device at the time of login;

FIG. 4 is a diagram illustrating an example of an information display screen when an arrangement position of a soft key is set to the right side of the screen;

FIG. 5 is a diagram illustrating an example of an information display screen when an arrangement position of a soft key is set to the left side of the screen;

FIG. 6 is a diagram illustrating an example of an information display screen when an arrangement position of a soft key is set to the upper side of the screen;

FIG. 7 is a diagram illustrating an example of an information display screen when an arrangement position of a soft key is set to the lower side of the screen; and

FIG. 8 is a flowchart for depicting an example of a flow of a process in which the inspection device displays the soft key.

### DETAILED DESCRIPTION

In accordance with an embodiment, an information processing apparatus includes a touch display configured to display an application screen; a memory that stores key layout information representing a plurality of layouts for software keys; and a processor configured to: control the touch display to display a selection screen for a user to select a display position of the software keys; control the touch display to display the software keys according to one of the layouts corresponding to the selected display position; and control the touch display to display the application screen next to the displayed software keys.

(Description of Hardware Configuration of Inspection Device)

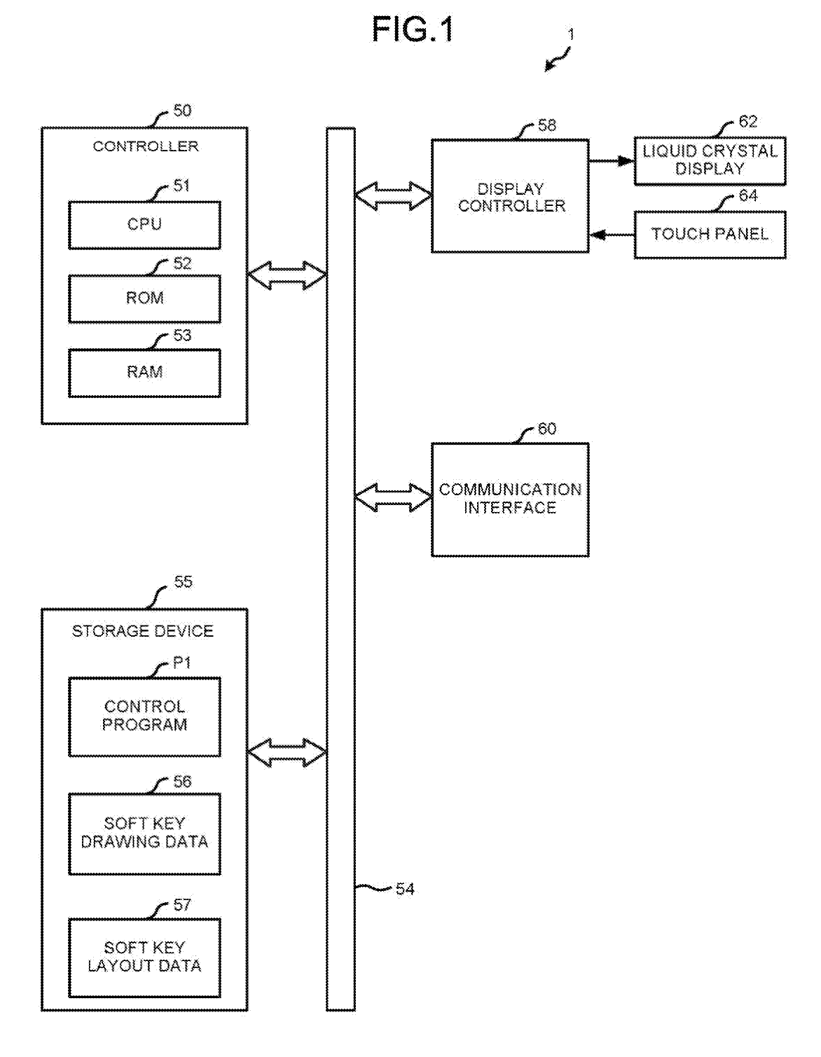

The inspection device which is an embodiment of the present invention will be described with reference to the accompanying drawings. FIG. 1 is a hardware block diagram illustrating a hardware configuration of the inspection device. For example, an inspection device 1 is installed in a warehouse of a retail store or the like and is used for registering an inspection result of an arrived commodity.

The inspection device 1 includes a controller 50 for controlling each component of the inspection device 1. The controller 50 includes a Central Processing Unit (CPU) 51, a Read Only Memory (ROM) 52, and a Random Access Memory (RAM) 53. The CPU 51 is connected to the ROM 52 and the RAM 53 via an internal bus (not shown) having an address bus and a data bus which are arranged in the controller 50. The CPU 51 copies or decompresses various programs stored in the ROM 52 and a storage device or medium 55 on the RAM 53. The CPU 51 operates in accordance with various programs copied or decompressed on the RAM 53 and governs the control of the inspection device 1 as a whole. In other words, the controller 50 has the functions of a general purpose computer.

The controller 50 is connected to the storage device 55, a display controller 58, and a communication interface 60 via a bus line 54.

The storage device 55 is a non-volatile memory such as a flash memory or the like in which stored information is retained even when the power supply thereof is turned off. The storage device 55 stores programs including a control program P1. The control program P1 is used for realizing a function of the inspection terminal 1. The storage device 55 stores soft key drawing data 56 and soft key layout data 57.

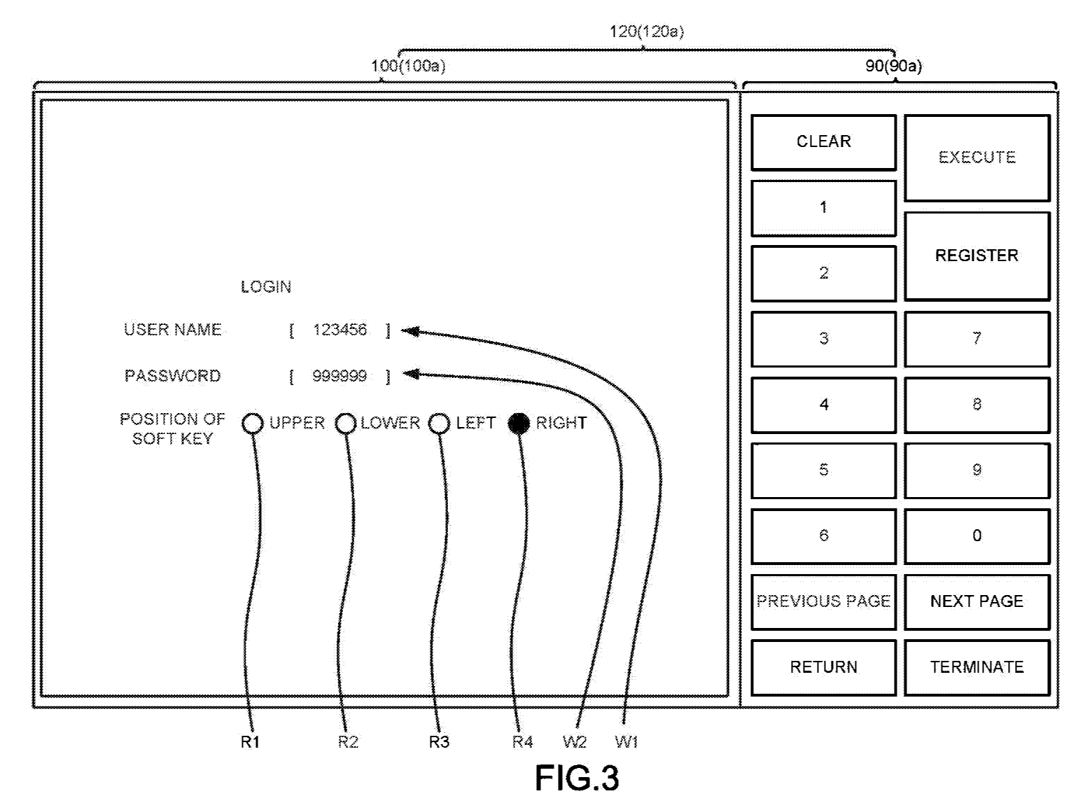

The soft key drawing data 56 is a drawing component of each key constituting a soft key 90 (refer to FIG. 3 to FIG. 7) displayed on a liquid crystal display 62. The soft key drawing data 56 is stored as image data such as a bit map image for each key.

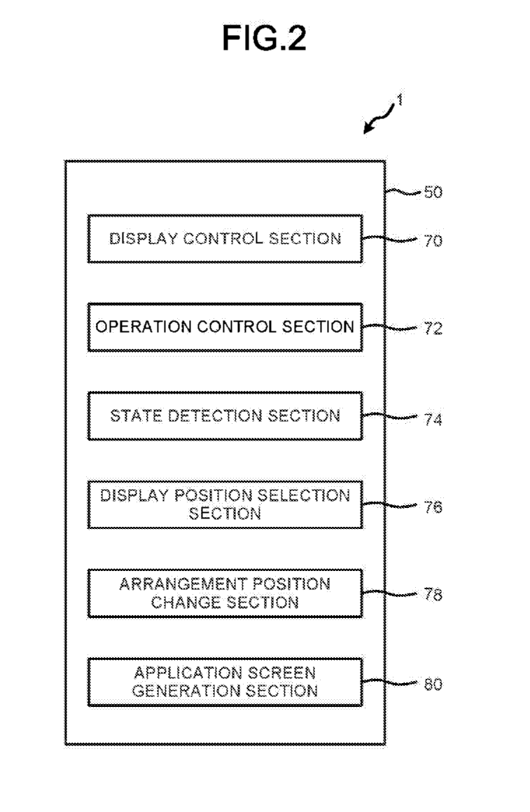

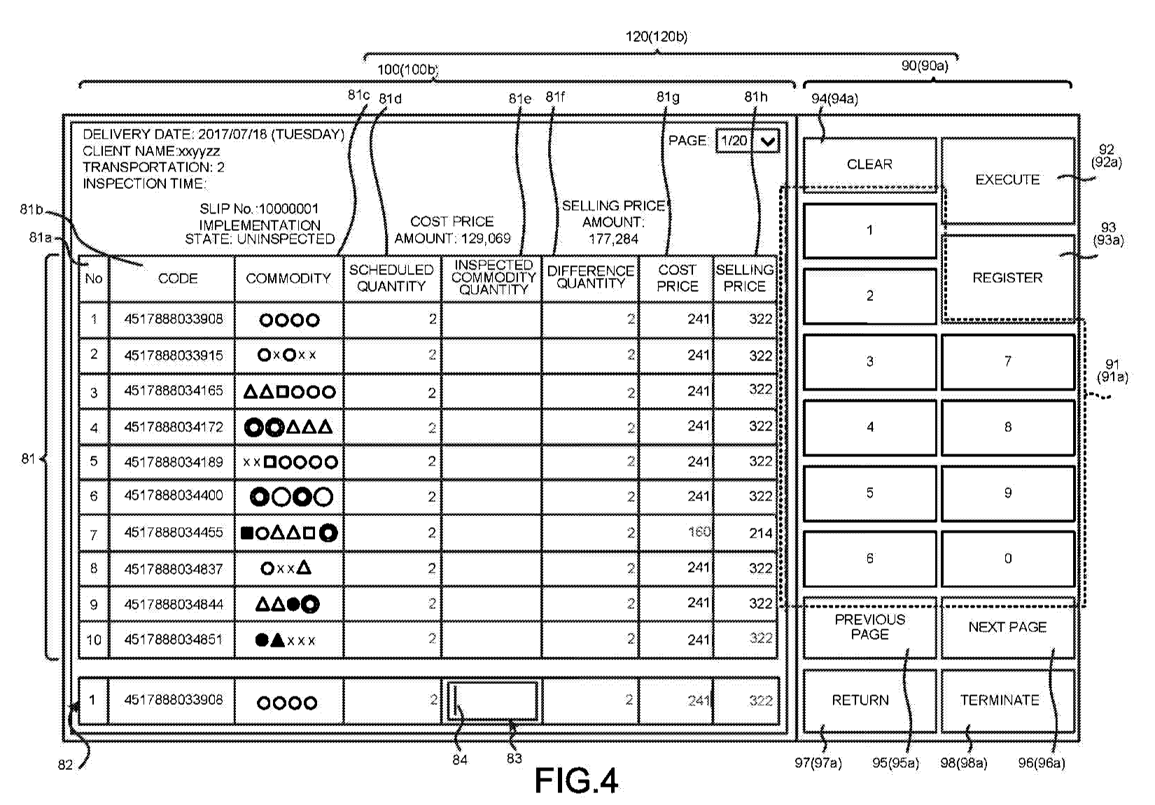

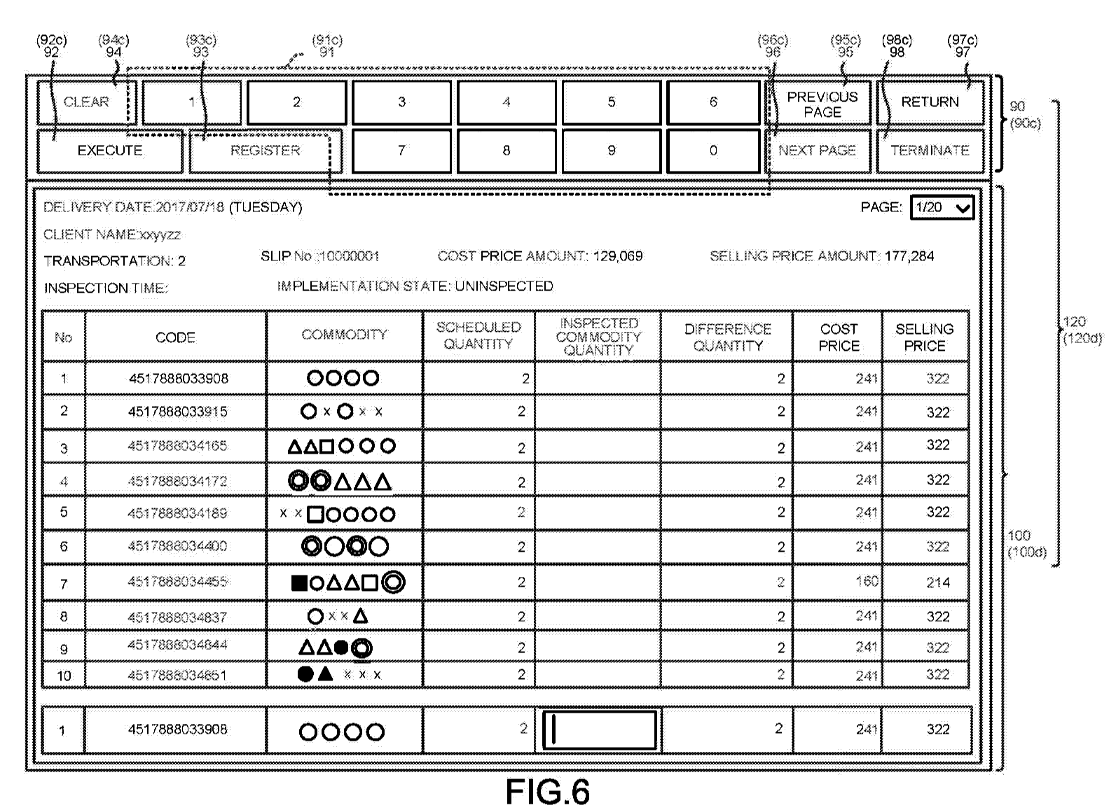

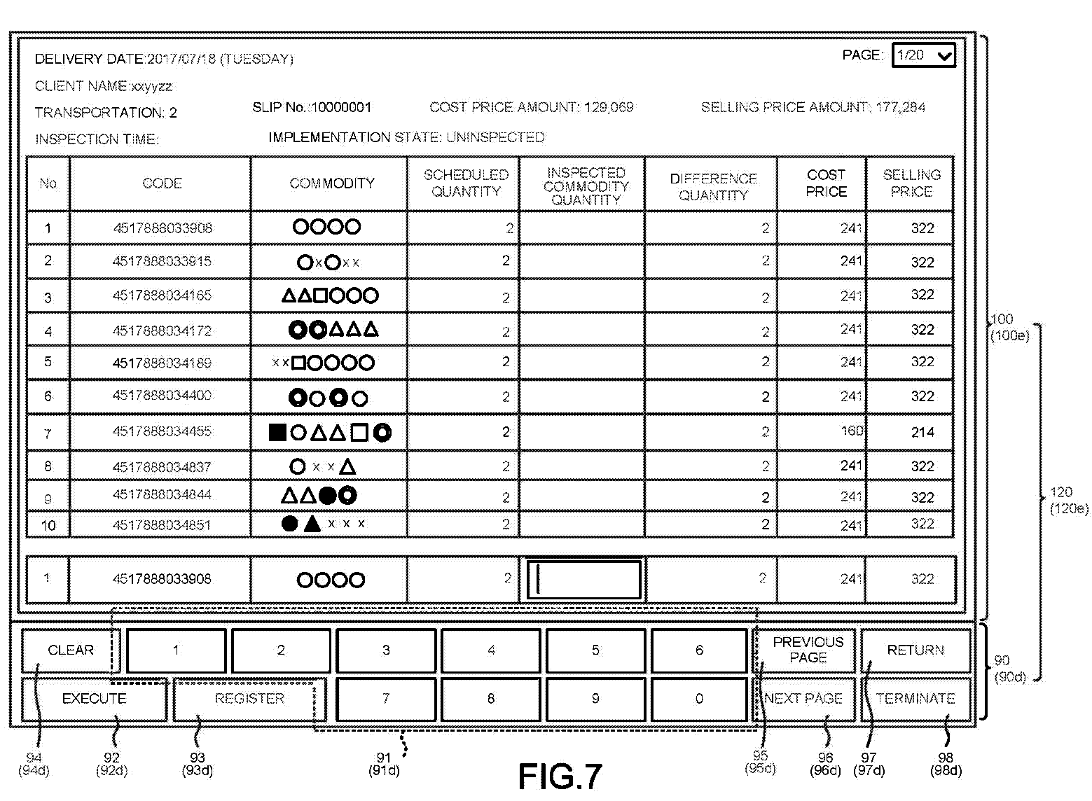

The soft key layout data 57 indicates a layout of each key of the soft key 90 displayed on the liquid crystal display 62. For example, the soft key layout data 57 is stored as coordinate data specifying a drawing position of each key for each layout position (for example, a left side, a right side, an upper side, a lower side, etc. of a display screen of the liquid crystal display 62) of the soft key 90. More specifically, the soft key layout data 57 stores the drawing position of each key in association with a display position of the soft key 90 selected by a display position selection section 76 (refer to FIG. 2) described later. In an embodiment, a layout of a soft key 90a (refer to FIG. 4), a layout of a soft key 90c (refer to FIG. 6), a layout of a soft key 90d (refer to FIG. 7) are stored as the soft key layout data 57.

The display controller 58 is connected to the liquid crystal display 62 and a touch panel 64. The display controller 58 controls connected hardware based on a command from the controller 50.

The liquid crystal display 62 (Liquid Crystal Display (LCD)) displays an application screen 100 (refer to FIG. 3 to FIG. 7) of the inspection device 1, and the soft key (refer to FIG. 3 to FIG. 7) described later.

The touch panel 64 is superimposed on the liquid crystal display 62. The liquid crystal display 62 may be an organic EL display device or the like. The touch panel 64 detects pressing (operation) on each cell (refer to FIG. 4) indicating a commodity catalog displayed on the liquid crystal display 62 and the soft key 90 (refer to FIG. 3 to FIG. 7), and controls an operation of the inspection device 1 in response to the pressed cell or the soft key 90.

The communication interface 60 is used for communicating with a store server (not shown) via a network such as an in-store Local Area Network (LAN). Specifically, the controller 50 of the inspection device 1 communicates with the store server via the communication interface 60 to receive delivery data of a commodity which is stored in the store server. The details thereof are described later.

(Description of Functional Component of the Inspection Device)

Next, the functional components of the inspection device 1 are described. FIG. 2 is a functional block diagram illustrating an example of the functional configuration of the inspection device 1. The CPU 51 of the controller 50 copies or decompresses the control program P1 in the storage device 55 on the RAM 53. The controller 50 operates in accordance with the control program P1 to generate functional sections shown in FIG. 2 on the RAM 53. Specifically, the controller 50 includes, as functional sections, a display control section 70, an operation control section 72, a state detection section 74, a display position selection section 76, an arrangement position change section 78 and an application screen generation section 80.

The display control section 70 displays the soft key 90 (refer to FIG. 3 to FIG. 7) at a position selected by the display position selection section 76 (described later) on the liquid crystal display 62. The display control section 70 displays an application screen 100 (refer to FIG. 3 to FIG. 7) generated by the application screen generation section 80 (described later) at a position corresponding to the soft key 90 on the liquid crystal display 62.

The operation control section 72 controls the touch panel 64 to detect pressing (operation) of the soft key 90 displayed on the liquid crystal display 62. Then, the operation control section 72 enables the inspection device 1 to perform an operation corresponding to the soft key 90 that is pressed.

The state detection section 74 detects whether the inspection device 1 is in a predetermined operating state. The predetermined operating state referred to here is, for example, a state in which the inspection device 1 is logged into. Here, the state detection section 74 may detect that the inspection device 1 is in a state in which the inspection device 1 starts an operation of the application instead of the state in which the inspection device 1 is logged into.

The display position selection section 76 receives selection of one display position from a plurality of preset display positions of the soft key 90 on the liquid crystal display 62.

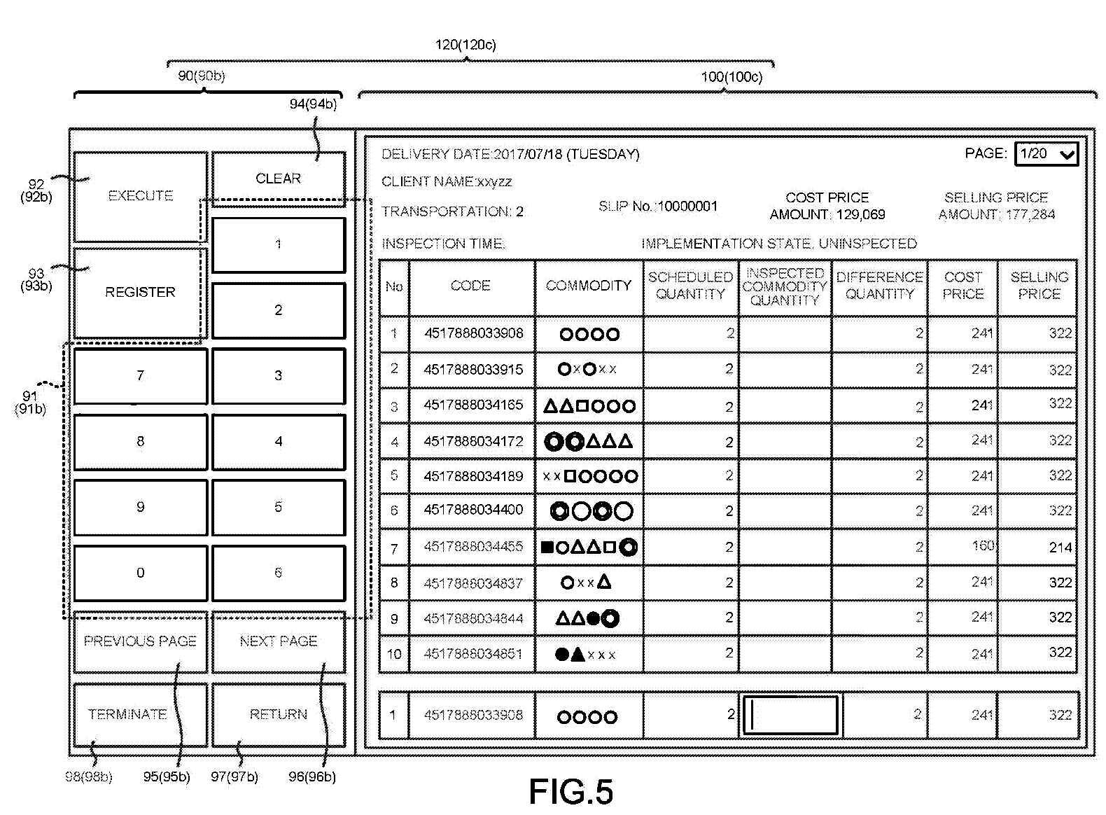

The arrangement position change section 78 changes arrangement positions of individual keys constituting the soft key 90 according to the display position of the soft key 90. If all of the soft key layout data 57 corresponding to all the display positions of the soft key 90 are stored, in order to increase a storage capacity of the storage device 55, only a reference layout of the soft key 90 may be stored in the soft key layout data 57. Then, if the layout of respective keys changes as the display position of the soft key 90 changes, the arrangement position change section 78 changes the reference layout of the soft key 90 to generate the suitable soft key 90 at the display position. In an embodiment, the layout of the soft key 90a (refer to FIG. 4) described later is stored as the soft key layout data 57, and the layout of the soft key 90b (refer to FIG. 5) is generated by the arrangement position change section 78. Specifically, the arrangement position change section 78 stores information indicating how the arrangement of the individual keys is changed according to the display position of the soft key 90. Based on the information about the arrangement of the individual keys, a soft key corresponding to the display position is generated.

The application screen generation section 80 generates the application screen 100 in response to the operating state of the inspection device 1 and the display position of the soft key 90. The application screen generation section 80 displays the generated application screen 100 at a position corresponding to the display position of the soft key 90.

(Description of Login Screen)

Next, an example of an information display screen displayed by the inspection device 1 on the liquid crystal display 62 is described with reference to FIG. 3 to FIG. 7.

First, FIG. 3 is a diagram illustrating an example of an information display screen 120 (120a) displayed by the inspection device 1 on the liquid crystal display 62 at the time of login. As shown in FIG. 3, the information display screen 120 (120a) includes the application screen 100 (100a) and the soft key 90.

The application screen 100 corresponds to the operating state of the inspection device 1. In FIG. 3, the application screen 100 (100a) is a login screen for operating the inspection device 1.

Specifically, at the time of login, the inspection device 1 displays a user name input window W1, a password input window W2, radio buttons R1, R2, R3, and R4 for selecting the display position of the soft key, and the soft key 90 on the liquid crystal display 62.

The user name input window W1 is used for an operator to input a user name when the operator logs into the inspection device 1. If the screen shown in FIG. 3 is displayed, the operator presses the user name input window W1 to input the user name. Thereafter, by pressing a numeric keypad in the soft key 90, the user name is input. FIG. 3 shows a state in which “123456” is input as an example of the user name.

The password input window W2 is used for the operator to input a password at the time of logging into the inspection device 1. If the screen shown in FIG. 3 is displayed, the operator presses the password input window W2 to input a password. Then, by pressing the numeric keypad in the soft key 90, the password is input. FIG. 3 shows a state in which “999999” is input as an example of the password.

The radio buttons R1, R2, R3, and R4 are switches for selecting the display position of the soft key 90. The operator selects where the soft key 90 is displayed on the liquid crystal display 62 by pressing any one of the radio buttons R1, R2, R3, and R4. FIG. 3 shows a state in which the radio button R4 is selected, i.e., a state in which the software key 90 is selected to be displayed on the right side of the screen.

The soft key 90 is used to input the user name and the password at the time of login. In the case of the login screen, the soft key 90 is displayed at a predetermined position. FIG. 3 shows an example in which the soft key 90 (90a) is displayed on the right side of the screen. The content of the soft key 90 (90a) is described later.

Here, it is described that the display position of the soft key 90 (90a, 90b, 90c, and 90d) is selected when the operator logs into the inspection device 1, but a timing of selecting the display position of the soft key 90 is not limited to the login timing. The timing of selecting the display position of the soft key 90 may be a timing at which the operation of the application of the inspection device 1 is started. In this case, another screen that allows the user to select one of the radio buttons R1, R2, R3, and R4 is displayed when the application is running after the user has logged into the inspection device 1.

(Description of the Information Display Screen with the Soft Key Arranged on the Right Side)

FIG. 4 is a diagram illustrating an example of the information display screen when the right side of the screen is selected as the arrangement position of the soft key 90 and the inspection device 1 executes an application for inspection. In this case, the information display screen 120 (120b) includes the application screen 100 (100b) and the soft key 90 (90a).

The application screen 100 (100b) is displayed when the inspection device 1 is in the operating state. In particular, the application screen 100b is an application screen when the soft key 90a is displayed on the right side of the screen.

The application screen 100b includes the delivery data 81 and a commodity column 82 for performing inspection. The delivery data 81 indicates a delivery state. The delivery data 81 includes a commodity number column 81a, a commodity code column 81b, a commodity name column 81c, a scheduled delivery commodity quantity column 81d, inspected commodity quantity column 81e, a difference quantity column 81f, a cost price column 81g, and a selling price column 81h.

The commodity number column 81a stores a serial number of a commodity to be delivered. The commodity code column 81b stores a commodity code (e.g., Japanese Article Number (JAN) code) of the commodity to be delivered. The commodity name column 81c stores a commodity name of the commodity to be delivered.

The scheduled delivery commodity quantity column 81d stores a scheduled quantity of the commodities to be delivered. The inspected commodity quantity column 81e stores the quantity of commodities that have been actually inspected. The difference quantity column 81f stores a difference between the scheduled quantity of the commodities to be delivered and the quantity of the commodities that have been actually inspected.

The cost price column 81g stores a cost price of the commodity. The selling price column 81h stores a selling price of the commodity.

The commodity column 82 for performing inspection stores delivery data of the commodity to be inspected, which is selected by the operator of the inspection device 1 from the delivery data 81. Specifically, the operator presses the commodity number column 81a of the delivery data 81 to select the commodity to be inspected. The delivery data 81 of the selected commodity is copied and displayed in the commodity column 82 for performing the inspection. The operator who performs the inspection inputs the quantity of inspected commodities using the numeric keypad 91 of the soft key 90 in the inspected commodity quantity input column 83. If the commodity column 82 for performing the inspection is displayed, the inspected commodity quantity input column 83 is focused and a cursor 84 is displayed while blinking. Therefore, the operator can input the quantity of the inspected commodities using the numeric keypad 91 without performing other operations. Then, by pressing the registration key after inputting the quantity of the inspected commodities, the input quantity of the inspected commodities is determined and the difference quantity (scheduled delivery commodity quantity−inspected commodity quantity) is calculated.

For example, in FIG. 4, if “2” is input as the inspected commodity quantity in the inspected commodity quantity input column 83, “0” is calculated as the difference quantity. Then, the calculated difference quantity is reflected in the difference quantity column 81f of the commodity column 82 which performs inspection. Then, if the registration key 93 is pressed, the content of the commodity column 82 for performing the inspection is reflected in the delivery data 81, and the commodity column 82 is cleared.

The operator of the inspection device 1 performs the same operation on all the commodities. If the quantity of the commodities to be delivered is large, the delivery data occupies plural pages. At this time, a page-up (page-down) operation is performed by pressing a previous page key 95 and a next page key 96 in the soft key 90.

If the quantity of the inspected commodity is input incorrectly, by pressing a clear key 94 in the soft key 90, it is possible to clear data (for example, the quantity of the inspected commodity) being input currently. By pressing a return key 97 in the soft key 90, it is possible to return to a state before one operation.

If all the inspection is completed, by pressing an execution key 92 in the soft key 90, the quantity of all input inspected commodities is determined. When the quantity of inspected commodities is determined, the delivery data 81 is stored in the storage device 55. Furthermore, the inspection data 81 for which the inspection is completed may be transmitted to the store server via the communication interface 60.

Then, by pressing a termination key 98 in the soft key 90, an application for performing inspection is terminated.

Next, the configuration of the soft key 90a is described. The soft key 90a indicates a soft key displayed on the right side of the screen in the soft key 90. The soft key 90a includes a numeric keypad 91a, an execution key 92a, a registration key 93a, a clear key 94a, a previous page key 95a, a next page key 96a, a return key 97a, and a termination key 98a. The functions of respective keys are as described above. The type of the key constituting the soft key 90a is not limited to the above. For example, an alphabet key or the like may be used as the soft key 90a.

The drawing data of each key constituting the soft key 90a is stored in the storage device 55 as the soft key drawing data 56. The layout data of the soft key 90a in which the soft key drawing data 56 is arranged at predetermined positions is stored in the storage device 55 as the soft key layout data 57 including coordinate data indicating the arrangement positions of respective keys, for example.

The respective keys constituting the soft key 90a are displayed according to the layout shown in FIG. 4. Specifically, the numeric keypad 91a is displayed by being aligned in numerical order. Thus, it is easy for an operator to find the necessary numeric key that he or she wants to operate.

The previous page key 95a and the next page key 96a are arranged in such a manner that the previous page key 95a is displayed on the left side, the next page key 96a is displayed on the right side, and the both are adjacent to each other. This reduces erroneous operations of the previous page key 95a and next page key 96a. The arrangement pattern in which the previous page key 95a is displayed on the left side, the next page key 96a is displayed on the right side, and the both are adjacent to each other is common to all of the display positions of the soft key 90 (refer to FIG. 5 to FIG. 7). As a result, even if the same operator changes the arrangement position of the soft key 90, the deterioration in the operability can be suppressed.

Since the execution key 92a and the registration key 93a have similar functions, they are displayed in an adjacent state. Since the registration key 93a is pressed after operation on the numeric keypad 91a, it is desirable that the registration key 93a is displayed at a position closer to the numeric keypad 91a.

The clear key 94a and the return key 97a have similar functions, but they are displayed with some space in an embodiment. For example, if an one-digit input error occurs in the input of a numerical value of a plurality of digits, the incorrect one-digit can be deleted as long as the return key 97a is pressed; however, if the clear key 94a is mistakenly pressed, the correctly input numerical values are all deleted. Therefore, in order to reduce such an operation error, it is desirable to draw the attention during operation by displaying the clear key 94a and the return key 97a with some distance.

Since the termination key 98a is operated each time an inspection process is terminated, it is desirable to display it at a corner position of the soft key 90a in order to facilitate familiarity with the operation.

(Description of the Information Display Screen with the Soft Key Arranged on the Left Side)

FIG. 5 is a diagram illustrating an example of the information display screen 120 (120c) when the soft key 90 is arranged on the left side of the screen.

The information display screen 120c includes an application screen 100c and a soft key 90b. The application screen 100c has the same content as the application screen 100b described above. However, because the display positions of the soft key 90a and the soft key 90b are different, the display position of the application screen 100c in the information display screen 120c is different from that of the application screen 100b. Specifically, the display position of the application screen 100c is obtained by translating the display position of the application screen 100b towards the right direction of the screen.

The contents of respective keys (numeric keypad 91b, execution key 92b, registration key 93b, clear key 94b, previous page key 95b, next page key 96b, return key 97b, and termination key 98b) constituting the soft key 90b are the same as those of the soft key 90a. However, the layout of respective keys constituting the soft key 90b is different from that of respective keys constituting the soft key 90a. Specifically, the numeric keypad 91b, the execution key 92b, the registration key 93b, the clear key 94b, the return key 97b, and the termination key 98b are arranged in a left and right reversed manner with respect to the numeric keypad 91a, the execution key 92a, the registration key 93a, the clear key 94a, the return key 97a, and the termination key 98a, correspondingly. The purpose of the arrangement of the soft key 90b is to improve the usability for the left-handed operator. Specifically, the soft key 90b is desirably arranged by reversing the respective keys constituting the soft key 90a arranged for the right-handed operator left and right.

However, the previous page key 95b and the next page key 96b are arranged in the same way as the previous page key 95a and the next page key 96a of the soft key 90a without performing the left and right reversion. The reason is as described above.

(Description of the Information Display Screen with the Soft Key Arranged on the Upper Side)

FIG. 6 is a diagram illustrating an example of an information display screen 120 (120d) when the soft key 90 is arranged on the upper side of the screen.

The information display screen 120d includes an application screen 100d and a soft key 90c. The application screen 100d has the same contents as the application screens 100b and 100c described above. However, since the display position of the soft key 90c is different from the display positions of the soft keys 90a and 90b, the display position of the application screen 100d in the information display screen 120d is different from the display positions of the application screens 100b and 100c. Specifically, the application screen 100d is obtained by enlarging the application screens 100b and 100c in a horizontal direction and reducing them in a vertical direction in the screen.

The contents of respective keys (numeric keypad 91c, execution key 92c, registration key 93c, clear key 94c, previous page key 95c, next page key 96c, return key 97c, and termination key 98c) constituting the soft key 90c are the same as those of respective keys constituting the soft keys 90a and 90b. However, the layout of respective keys constituting the soft key 90c is different from that of respective keys constituting the soft keys 90a and 90b. In other words, the respective keys constituting the soft key 90c are arranged in the horizontal direction of the information display screen 120d.

However, when changing the layout of respective keys, the layout of the soft key 90c is the same as that of the soft keys 90a and 90b in a point that the numeric keypad 91c is aligned together, a point that the previous page key 95c and the next page key 96c are displayed adjacent to each other (the both are adjacent to each other horizontally in FIG. 4 while adjacent to each other vertically in FIG. 6), and a point that the execution key 92c and the registration key 93c are displayed adjacent to each other. Furthermore, the layout of the soft key 90c are the same as that of the soft keys 90a and 90b in a point that the clear key 94c and the return key 97c are displayed with some distance and a point that the termination key 98c is displayed at a corner position.

(Description of the Information Display Screen with the Soft Key Arranged on the Lower Side)

FIG. 7 is a diagram illustrating an example of the information display screen 120 (120e) when the soft key 90 is arranged on the lower side of the screen.

The information display screen 120e includes an application screen 100e and a soft key 90d. The application screen 100e has the same contents as the application screens 100b, 100c and 100d described above. However, since the display position of the soft key 90d is different from the display positions of the soft keys 90a, 90b and 90c, the application screen 100e is obtained by translating the display position of the application screen 100d upwards in the screen.

The contents of respective keys (numeric keypad 91d, execution key 92d, registration key 93d, clear key 94d, previous page key 95d, next page key 96d, return key 97d, and termination key 98d) constituting the soft key 90d are the same as those of respective keys constituting the soft keys 90a, 90b and 90c. The layout of respective keys constituting the soft key 90d is the same as that of the soft key 90c.

The setting (refer to FIG. 6) for displaying the soft key 90c on the upper side of the application screen 100d is selected when the operator is tall and can touch the upper side of the information display screen 120 more easily if the operator operates the liquid crystal display 62 hung on the wall while standing. The setting (refer to FIG. 7) for displaying the soft key 90d on the lower side of the application screen 100e is selected when the operator is short and can touch the lower side of the information display screen 120 more easily if the operator operates the liquid crystal display 62 hung on the wall while standing.

(Description of Display Form of the Application Screen According to Display Position of the Soft Key)

As described above, the display form of the application screen 100 (100a, 100b, 100c, 100d, and 100e) is different depending on the display position of the soft key 90 (90a, 90b, 90c, and 90d). Specifically, the application screen 100 is displayed by adjusting vertical and horizontal sizes thereof respectively in an empty space when the soft key 90 is displayed in the information display screen 120. The size adjustment of the application screen 100 and the setting of the display position thereof are performed by the application screen generation section (refer to FIG. 2) described above.

Specifically, the application screen generation section 80 compares a vertical size and a horizontal size of the empty space when displaying the soft key 90 with a vertical size and a horizontal size of the application screen 100, respectively. Next, a magnification of the vertical size and a magnification of the horizontal size are respectively determined such that the vertical size and the horizontal size of the application screen 100 match those of the empty space when displaying the soft key 90. Then, the application screen generation section 80 changes the vertical size and the horizontal size of the application screen 100 based on the determined magnification of the vertical size and magnification of the horizontal size, and draws them on the information display screen 120.

(Description of a Flow of a Process in which the Inspection Device Displays a Soft Key)

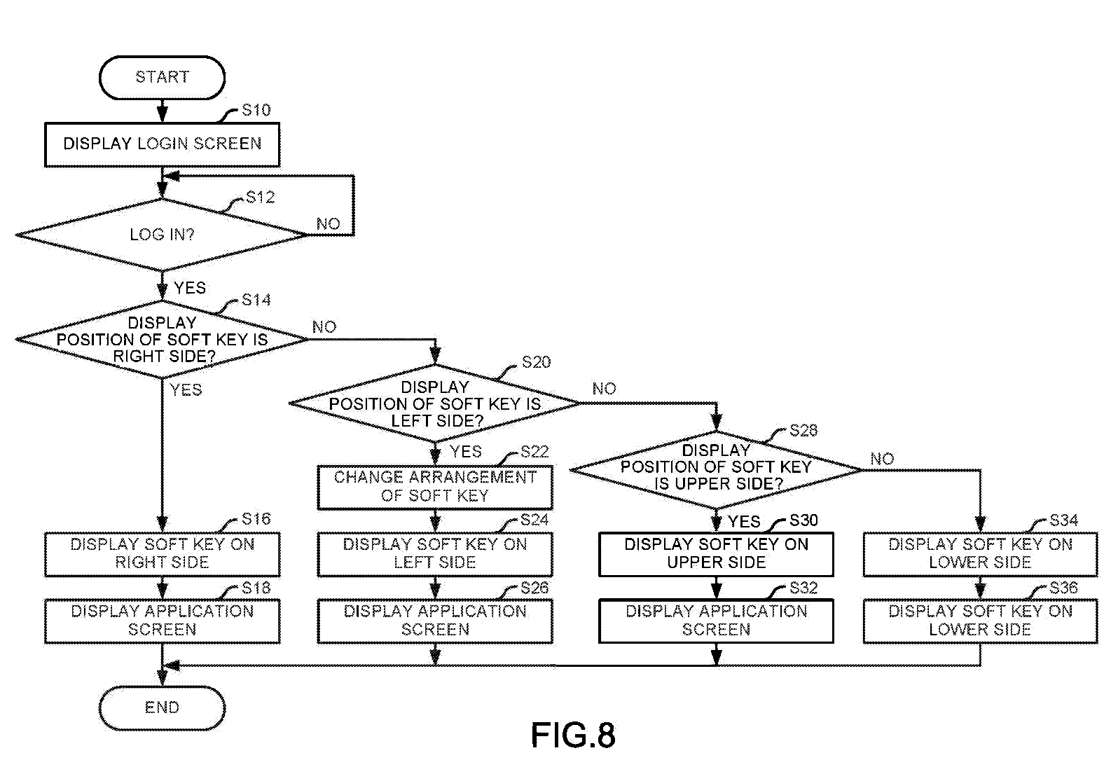

Next, a flow of a process in which the inspection device 1 displays the soft key is described. FIG. 8 is a flowchart for depicting an example of a flow of a process in which the inspection device 1 displays the soft key.

The display control section 70 generates the login screen and displays it on the liquid crystal display 62 (Act S10).

The state detection section 74 determines whether the inspection device 1 is logged into after a login operation (Act S12). If it is determined that the inspection device 1 is logged into (Yes in Act S12), the flow proceeds to the process in Act S14. On the other hand, if it is determined that the inspection device 1 is not logged into (No in Act S12), the process in Act S12 is repeated.

The display position selection section 76 determines whether the right side of the liquid crystal display 62 is selected as the display position of the soft key 90 (Act S14). If it is determined that the right side of the liquid crystal display 62 is selected as the display position of the soft key 90 (Yes in Act S14), the flow proceeds to the process in Act S16.

In Act S16, the display control section 70 displays the soft key 90a on the right side of the liquid crystal display 62. At this time, the display control section 70 reads out the drawing data of each key stored in the soft key drawing data 56 (refer to FIG. 1). The display control section 70 generates the drawing data of the soft key 90a by applying the read drawing data to the layout of the soft key 90a which is stored as the soft key layout data 57.

Next, in Act S18, the application screen generation section 80 generates the application screen 100b when the soft key 90a is displayed on the right side of the liquid crystal display 62. Then, the display control section 70 displays the application screen 100b on the liquid crystal display 62. Thereafter, the process in FIG. 8 is terminated.

In Act S14, if it is determined that the right side of the liquid crystal display 62 is not selected as the display position of the soft key 90 (No in Act S14), the flow proceeds to the process in Act S20.

In Act S20, the display position selection section 76 determines whether the left side of the liquid crystal display 62 is selected as the display position of the soft key 90. If it is determined that the left side of the liquid crystal display 62 is selected as the display position of the soft key 90 (Yes in Act S20), the flow proceeds to the process in Act S22.

In Act S22, the arrangement position change section changes the arrangement of the individual keys constituting the soft key 90 to the arrangement when the soft key 90 is displayed on the left side of the liquid crystal display 62. At this time, the arrangement position change section 78 reads out the layout data of the soft key 90a which is stored as the soft key layout data 57 (refer to FIG. 1). Then, the arrangement position change section 78 changes the arrangement position of individual keys and generates the drawing data of the soft key 90b.

Next, in Act S24, the display control section 70 displays the drawing data of the soft key 90b generated in Act S22 on the left side of the liquid crystal display 62.

Next, in Act S26, the application screen generation section 80 generates the application screen 100c when the soft key 90b is displayed on the left side of the liquid crystal display 62. Then, the display control section 70 displays the application screen 100c on the liquid crystal display 62. Thereafter, the process in FIG. 8 is terminated.

In Act S20, if it is determined that the left side of the liquid crystal display 62 is not selected as the display position of the soft key 90 (No in Act S20), the flow proceeds to the process in Act S28.

In Act S28, the display position selection section 76 determines whether the upper side of the liquid crystal display 62 is selected as the display position of the soft key 90. If it is determined that the upper side of the liquid crystal display 62 is selected as the display position of the soft key 90 (Yes in Act S28), the flow proceeds to the process in Act S30.

In Act S30, the display control section 70 displays the soft key 90c on the upper side of the liquid crystal display 62. At this time, the display control section 70 reads out the drawing data of each key stored in the soft key drawing data 56. The display control section 70 generates the drawing data of the soft key 90c by applying the read drawing data to the layout of the soft key 90c which is stored as the soft key layout data 57.

Next, in Act S32, the application screen generation section 80 generates the application screen 100d when the soft key 90c is displayed on the upper side of the liquid crystal display 62. Then, the display control section 70 displays the application screen 100d on the liquid crystal display 62. Thereafter, the process in FIG. 8 is terminated.

In Act S28, if it is determined that the upper side of the liquid crystal display 62 is not selected as the display position of the soft key 90 (No in Act S28), the flow proceeds to the process in Act S34.

In Act S34, the display control section 70 displays the soft key 90d on the lower side of the liquid crystal display 62. At this time, the display control section 70 reads the drawing data of each key stored in the soft key drawing data 56. The display control section 70 generates the drawing data of the soft key 90d by applying the read drawing data to the layout of the soft key 90d which is stored as the soft key layout data 57.

Next, in Act S36, the application screen generation section 80 generates the application screen 100e when the soft key 90d is displayed on the lower side of the liquid crystal display 62. Then, the display control section 70 displays the application screen 100e on the liquid crystal display 62. Thereafter, the process in FIG. 8 is terminated.

According to the inspection device 1 of an embodiment, from the plurality of preset display positions of the soft key 90, the display control section 70 displays the soft key 90 at a position on the liquid crystal display 62 which is selected with the display position selection section 76, and displays the application screen 100 generated by the application screen generation section 80 at a position in response to the display position of the soft key 90. Therefore, the soft key 90 can be displayed at a convenient position for the operator.

The inspection device 1 of an embodiment further comprises the state detection section 74 which detects that the inspection device 1 is in a predetermined operating state, and on condition that the inspection device 74 detects that the inspection device 1 is in the predetermined state, the display position selection section 76 receives the selection of the display position of the soft key 90. Therefore, depending on the state of the inspection device 1, the soft key 90 can be displayed in an appropriate position.

According to the inspection device 1 of an embodiment, the state detection section 74 detects that the inspection device 1 is in the login state as the predetermined operating state. Therefore, even when a plurality of operators logs in using the same identification code in a shared terminal or the like, the display position of the soft key 90 can be set for each operator.

Furthermore, according to the inspection device 1 of an embodiment, the state detection section 74 detects that the inspection device 1 is in a state in which the operation of the application is started as the predetermined operating state. Therefore, according to the content of the application, the soft key 90 can be displayed in the appropriate position.

According to the inspection device 1 of an embodiment, the arrangement position change section 78 changes the arrangement positions of the individual keys constituting the soft key 90 according to the display position of the soft key 90 selected with the display position selection section 76. Therefore, even when the display position of the soft key 90 is changed, the operability of the soft key 90 can be maintained. It is unnecessary to store the soft key layout data 57 corresponding to all the display positions of the soft key 90. Therefore, the storage capacity of the storage device 55 can be reduced.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, the arrangement position change section changes the arrangement of the individual keys constituting the soft key 90 according to the display position of the soft key 90 selected with the display position selection section 76 (for example, refer to Act S22 in FIG. 8). However, if there is room in the storage capacity of the storage device 55, the soft key layout data 57 corresponding to all the display positions of the soft key 90 may be stored in the storage device 55, and then the soft key layout data 57 corresponding to the selection result of the display position selection section 76 is read out to be used as the drawing data of the soft key 90.

What is claimed is:

1. An information processing apparatus, comprising:
a touch display configured to display an application screen;
a memory that stores key layout information representing a plurality of layouts for software keys; and
a processor configured to:
control the touch display to display a selection screen for a user to select a display position of the software keys;
control the touch display to display the software keys according to one of the layouts corresponding to the selected display position; and
control the touch display to display the application screen next to the displayed software keys.

2. The information processing apparatus according to claim 1, wherein
the processor controls the touch display to accept the selection of the display position from the user on condition that the information processing apparatus is in a predetermined state.

3. The information processing apparatus according to claim 2, wherein
the processor controls the touch display to accept the selection of the display position when the user logs into the information processing apparatus.

4. The information processing apparatus according to claim 2, wherein
the processor controls the touch display to accept the selection of the display position in a state where an application that displays the application screen has been started.

5. The information processing apparatus according to claim 1, wherein
the selection screen allows the user to select one of an upper position, a lower position, a left position, and a right position, as the display position of the software keys.

6. The information processing apparatus according to claim 5, wherein
the software keys include numeric keys, and
a layout for the numeric keys at the left position and a layout for the numeric keys at the right position are symmetrical.

7. The information processing apparatus according to claim 6, wherein
the software keys include a pair of page keys; and
the pair of page keys is arranged at a same position in layouts for the left and the right position.

8. The information processing apparatus according to claim 6, wherein
a layout for the numeric keys at the upper position and a layout for the numeric keys at the lower position are identical.

9. The information processing apparatus according to claim 1, wherein
the processor controls the touch display to show a list of commodities to be inspected in the application screen.

10. The information processing apparatus according to claim 9, wherein
the processor controls the touch display to show an input field for one of the commodities being inspected by the user.

11. A method performed by an information processing apparatus configured to display an application screen on a touch display, comprising:
displaying on the touch display a selection screen for a user to select a display position of software keys;
displaying on the touch display the software keys according to one of a plurality of layouts stored in a memory corresponding to the selected display posit ion; and
displaying on the touch display the application screen next to the displayed software keys.

12. The method according to claim 11, further comprising
accepting the selection of the display position from the user on condition that the information processing apparatus is in a predetermined state.

13. The method according to claim 12, wherein
the selection of the display position is accepted when the user logs into the information processing apparatus.

14. The method according to claim 12, wherein
the selection of the display position is accepted in a state where an application that displays the application screen has been started.

15. The method according to claim 11, wherein
the selection screen allows the user to select one of an upper position, a lower position, a left position, and a right position, as the display position of the software keys.

16. The method according to claim 15, wherein
the software keys include numeric keys, and
a layout for the numeric keys at the left position and a layout for the numeric keys at the right position are symmetrical.

17. The method according to claim 16, wherein
the software keys include a pair of page keys; and
the pair of page keys is arranged at a same position in layouts for the left and the right position.

18. The method according to claim 16, wherein
a layout for the numeric keys at the upper position and a layout for the numeric keys at the lower position are identical.

19. The method according to claim 11, wherein
the application screen shows a list of commodities to be inspected.

20. A non-transitory computer readable medium storing a program causing a computer to execute a display process comprising the steps of:
displaying on a touch display a selection screen for a user to select a display position of software keys;
displaying on the touch display the software keys according to one of a plurality of layouts stored in a memory corresponding to the selected display position; and
displaying on the touch display an application screen next to the displayed software keys.
